(19) United States
(12) Patent Application Publication
(10) Pub. No.: US 2024/0385005 A1
(43) Pub. Date: Nov. 21, 2024

(54) METHOD

(71) Applicant: TOYOTA JIDOSHA KABUSHIKI KAISHA, Toyota-shi (JP)

(72) Inventors: Ryosuke KOBAYASHI, Nagakute-shi (JP); Koichi WATANABE, Tokyo (JP); Motofumi KAMIYA, Nagoya-shi (JP); Masaki NISHINO, Anjo-shi (JP); Jean-Sebastien BOIRE, Yokohama-shi (JP); Takuya NISHIOKA, Nagoya-shi (JP); Yohei NAKANISHI, Nagoya-shi (JP); Masaki MAKIHARA, Okazaki-shi (JP)

(73) Assignee: TOYOTA JIDOSHA KABUSHIKI KAISHA, Toyota-shi (JP)

(21) Appl. No.: 18/429,800

(22) Filed: Feb. 1, 2024

(30) Foreign Application Priority Data
May 19, 2023 (JP) 2023-083393

(51) Int. Cl. G01C 21/36; G01C 21/34; G06Q 10/02

(52) U.S. Cl. CPC G01C 21/3679; G01C 21/3492; G01C 21/3617; G06Q 10/02

(57) ABSTRACT

The method is a method executed by a control device used for providing a charging service in which a power supply vehicle used for charging a vehicle moves to the source of the vehicle and charges the vehicle, and includes: acquiring usage date and time information indicating a date and time a user wants to use the charging service; acquiring parking lot information indicating a parking lot attached to a facility that can be used for the charging service; acquiring privilege information indicating a privilege available at the facility when the charging service is used in a parking lot; and notifying the user of the parking lot information and the privilege information.

### CROSS-REFERENCE TO RELATED APPLICATION

This application claims priority to Japanese Patent Application No. 2023-083393 filed on May 19, 2023, incorporated herein by reference in its entirety.

### BACKGROUND

### 1. Technical Field

The present disclosure relates to methods.

### 2. Description of Related Art

Technology of providing a charging service is conventionally known in the art. For example, Japanese Unexamined Patent Application Publication No. 2019-086841 (JP 2019-086841 A) discloses a technique in which, when an electrified vehicle runs out of power, a moving object for supplying power moves to the electrified vehicle and supplies power to the electrified vehicle.

### SUMMARY

It is conceivable that a power supply vehicle used to charge a vehicle uses a parking lot attached to a facility in order to provide a charging service. There is room for improvement in technique of providing a charging service.

It is an object of the present disclosure made in view of such circumstances to improve the technique of providing a charging service.

A method according to an embodiment of the present disclosure is performed by a control device that is used to provide a charging service in which a power supply vehicle used to charge a vehicle moves to the vehicle and charges the vehicle. The method includes:
acquiring usage date and time information indicating a date and time a user wants to use the charging service;
acquiring parking lot information indicating a parking lot attached to a facility and available for the charging service;
acquiring privilege information indicating a privilege available for use at the facility when the charging service is used in the parking lot; and
notifying the user of the parking lot information and the privilege information.

According to an embodiment of the present disclosure, it is possible to improve the technique of providing a charging service.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a schematic configuration of a system according to an embodiment of the present disclosure;

FIG. 2 is a block diagram illustrating a schematic configuration of a system according to an embodiment of the present disclosure;

FIG. 3 is a flowchart showing an operation of the control device according to the present embodiment; and

FIG. 4 is a flowchart showing the operation of the control device according to a modification.

### DETAILED DESCRIPTION OF EMBODIMENTS

Hereinafter, an embodiment of the present disclosure will be described.

### Outline of Embodiment

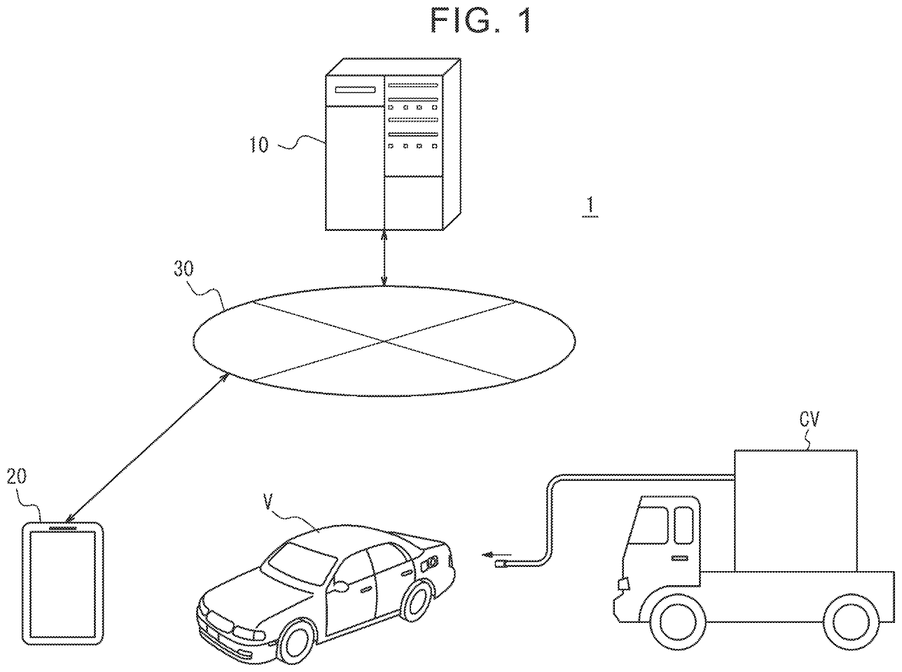

The outline of a system 1 according to an embodiment of the present disclosure will be described with reference to FIG. 1. The system 1 includes a control device 10 and a terminal device 20. The control device 10 and the terminal device 20 are communicably connected to a network 30 including, for example, the Internet and a mobile communication network.

The system 1 according to the present embodiment is used to provide a so-called running charging service. The running charging service is a service in which a user who desires to charge the vehicle V is requested, and a power supply vehicle CV capable of charging the vehicle V moves out of the vehicle V to charge the vehicle V. Specifically, after the power supply vehicle CV arrives at the source of the vehicle V, the vehicle V or the driver of the power supply vehicle CV connects the vehicle V and the power supply vehicle CV with each other by cabling, and charges the battery of the vehicle V. After the charging operation is completed, the power supply vehicle CV returns to the business operator providing the charging service.

In the present embodiment, an example of charging the vehicle V of the user from the power supply vehicle CV will be described, but the form of the running charging service is not limited thereto, and for example, a form in which a power supply device equipped with a storage battery capable of charging the vehicle V is loaded and carried to the source of the vehicle V by the transportation vehicle, and the power supply device may be recovered after the completion of the charging operation.

The control device 10 is installed in a facility such as a data center. The control device 10 is, for example, a server belonging to a cloud computing system or another computing system.

The terminal device 20 is held by the user. The terminal device 20 is, for example, a mobile device such as a mobile phone, a smart phone, or a tablet, or a PC. PC is an abbreviation for personal computer.

The network 30 includes the Internet, at least one WAN, at least one MAN, or a combination thereof. WAN is an abbreviation for wide area network. MAN is an abbreviation for metropolitan area network. The network 30 may include at least one wireless network, at least one optical network, or a combination thereof. The wireless network is, for example, an ad hoc network, a cellular network, a wireless LAN, a satellite communication network, or a terrestrial microwave network. The term “LAN” is an abbreviation for “local area network”.

Vehicle V is any type of vehicle that uses electrical power for at least part of its drive, such as Battery Electric Vehicle (BEV), Hybrid Electric Vehicle (HEV), Plug-in Hybrid Electric Vehicle (PHEV), or Fuel Cell Electric Vehicle (FCEV). The vehicle V is a vehicle on which a user rides. The vehicle V includes a control unit, a communication unit, and a positioning unit, and is capable of generating vehicle position information indicating the position of the vehicle V and transmitting the vehicle position information to an external device.

The vehicle V and the power supply vehicle CV may be movable by automated driving. The autonomous driving includes, for example, levels 1 to 5 defined in Society of Automotive Engineers (SAE), but is not limited thereto, and may be arbitrarily defined.

First, the outline of the present embodiment will be described, and the details will be described later. The control device 10 is used to provide a charging service in which the power supply vehicle CV used for charging the vehicle V moves to the source of the vehicle V to charge the vehicle V. The control device 10 acquires usage date and time information indicating a date and time the user wants to use the charging service. The control device 10 acquires parking lot information indicating a parking lot attached to a facility and available for a charging service. The control device 10 acquires privilege information indicating a privilege that can be used in a facility when a charging service is used in a parking lot. The control device 10 notifies the user of the parking lot information and the privilege information.

According to the present embodiment, a parking lot attached to a facility and available to be temporarily used by the power supply vehicle CV to provide an on-demand charging service and a privilege available for use at the facility are automatically presented to the user. Since the user can use the parking lot of various facilities, the convenience of the running charging service is improved. For the facility side, it becomes easier for the user to use the facility by using the privilege, and an effect of increasing the number of users of the facility occurs. Therefore, it is possible to improve a technique for providing a charging service.

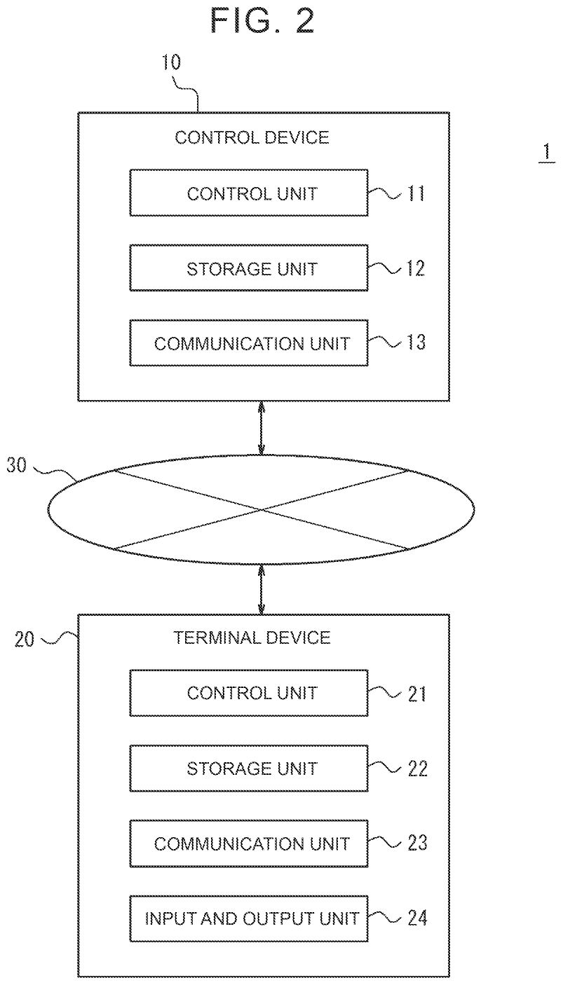

Next, each configuration of the system 1 will be described in detail with reference to FIG. 2.

### Control Device 10

The control device 10 includes a control unit 11, a storage unit 12, and a communication unit 13.

The control unit 11 includes at least one processor, at least one dedicated circuit, or a combination thereof. The processor may be a general-purpose processor, such as a CPU or GPU, or a special-purpose processor specialized for a particular process. “CPU” is an abbreviation for central processing unit. “GPU” is an abbreviation for graphics processing unit. The dedicated circuitry is, for example, a FPGA or a ASIC. “FPGA” is an abbreviation for field-programmable gate array. “ASIC” is an abbreviation for application specific integrated circuit. The control unit 11 executes processing related to the operation of the control device 10 while controlling each unit of the control device 10.

The storage unit 12 includes at least one semiconductor memory, at least one magnetic memory, at least one optical memory, or a combination of at least two of these. The memories are, for example, RAM or ROM. “RAM” is an abbreviation for random access memory. “ROM” is an abbreviation for read only memory. RAM is, for example, SRAM or DRAM. “SRAM” is an abbreviation for static random access memory. “DRAM” is an abbreviation for dynamic random access memory. ROM is, for example, EEPROM. “EEPROM” is an abbreviation for electrically erasable programmable read only memory. The storage unit 12 functions as, for example, a main storage device, an auxiliary storage device, or a cache memory. The storage unit 12 stores information used for the operation of the control device 10 and information obtained by the operation of the control device 10. For example, the storage unit 12 may store a system program, an application program, a database, map information, and the like. The information stored in the storage unit 12 may be updatable by information acquired from the network 30 via the communication unit 13.

The communication unit 13 includes at least one communication interface. The communication interface is, for example, a LAN interface or an interface corresponding to a mobile communication standard such as LTE, 4G or 5G. The term “LTE” is an abbreviation for “long term evolution”. The term “4G” is an abbreviation for “fourth generation”. The term “5G” is an abbreviation for “fifth generation”. The communication unit 13 receives data used for the operation of the control device 10 and transmits data obtained by the operation of the control device 10.

### Terminal 20

The terminal device 20 includes a control unit 21, a storage unit 22, a communication unit 23, and an input/output unit 24.

The hardware configurations of the control unit 21, the storage unit 22, and the communication unit 23 of the terminal device 20 may be the same as the hardware configurations of the control unit 11, the storage unit 12, and the communication unit 13 of the control device 10, respectively. The description here is omitted.

The input/output unit 24 includes at least one input-output interface. The input/output interface includes a touch screen integrally provided with the display. The input/output unit 24 receives an operation of inputting information used for the operation of the terminal device 20, and outputs information obtained by the operation of the terminal device 20. Instead of being provided in the terminal device 20, the input/output unit 24 may be connected to the terminal device 20 as an external input device. As a connection method, for example, any method such as a universal serial bus (USB), a high-definition multimedia interface (HDMI) (registered trademark), or Bluetooth (registered trademark) can be used. The input/output unit 24 may not be integrated, but may be constituted by a separate input unit and an output unit. In this case, the input unit includes at least one input interface such as a physical key, a capacitive key, a pointing device, or a microphone. The output includes at least one output interface such as a display or a speaker.

### Program

The function of the control device 10 or the terminal device 20 is implemented by executing the program according to the present embodiment by a processor corresponding to the control unit 11 or the control unit 21 or the like. That is, the functions of the control device 10 or the terminal device 20 are realized by software. The program causes the computer to execute the operation of the terminal device 20, thereby causing the computer to function as the control device 10 or the terminal device 20. That is, the computer functions as the control device 10 or the terminal device 20 by executing the operation of the control device 10 or the terminal device 20 in accordance with the control program.

The program can be stored in a non-transitory computer-readable medium. The non-transitory computer-readable medium in this embodiment is a ROM. Non-limiting examples of the non-transitory computer-readable medium include a magnetic recording device, an optical disk, and a magneto-optical recording medium. The distribution of the program is carried out, for example, by selling, transferring, or renting a portable medium such as a DVD or a CD-ROM in which the program is stored. The term “DVD” is an abbreviation for “digital versatile disc”. The term “CD-ROM” is an abbreviation for “compact disc read-only memory”. The program may be stored in the storage of the server and transferred from the server to other computers to distribute the program. The program may be provided as a program product.

The computer temporarily stores the program stored in the portable medium or the program transferred from the server in the main storage device, for example. The computer then causes the processor to read the program stored in the main storage device, and causes the processor to execute processes in accordance with the read program. The computer may read the program directly from the portable medium and execute processes in accordance with the program. The computer may execute the processes in accordance with the received program every time the program is transferred from the server to the computer. The processes may be executed by a so-called ASP service that realizes the function only by execution instruction and result acquisition without transferring the program from the server to the computer. The term “ASP” is an abbreviation for “application service provider”. The program includes information that is used for processing by electronic computers and equivalent to a program. For example, data that is not a direct command to a computer but has the property of defining the process of the computer corresponds to the “data equivalent to a program”.

Part or all of the functions of the control device 10 or the terminal device 20 may be realized by a programmable circuit or a dedicated circuit as the control unit 11 or the control unit 21. That is, some or all of the functions of the control device 10 or the terminal device 20 may be realized by hardware.

### Operation Flow of the Control Device

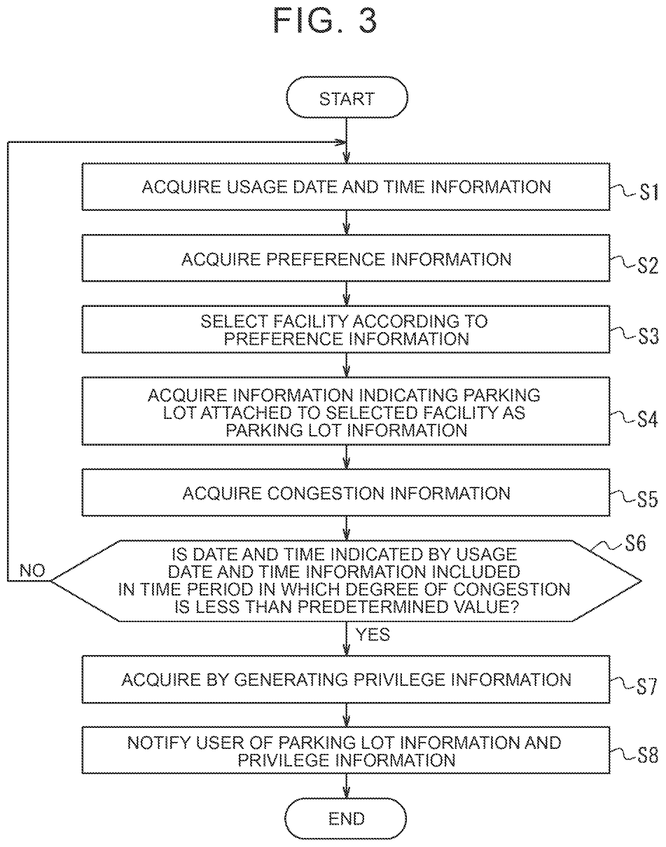

The operation of the control device 10 according to the present embodiment will be described with reference to FIG. 3. This operation corresponds to the method according to the present embodiment. Hereinafter, the control device 10 transmits and receives information to and from each device via the communication unit 13 and the network 30.

In S1 of FIG. 3, the control unit 11 of the control device 10 acquires usage date and time information indicating a date and time the user wants to use the charging service.

Any method may be used to acquire the usage date and time information. In the present embodiment, the control unit 11 acquires the usage date and time information from the terminal device 20 of the user. The present disclosure is not limited to this, and the control unit 11 may acquire the usage date and time information from the vehicle V.

In S2, the control unit 11 acquires preference information indicating a preference of the user. Any method may be employed for obtaining the preference information. The control unit 11 may acquire the preference information by reading it from the storage unit 12. The present disclosure is not limited thereto, and the control unit 11 may acquire the preference information by receiving the preference information from the terminal device 20 of the user.

The preference information is information indicating the identifier of the user and the preference of the user in association with each other. The preferences of the user include sports activities or watching, creation or appreciation of works of art such as music or craft, riding a car or a motorcycle, beauty, travel, eating and walking, shopping, cooking, games, and the like. For example, the control unit 11 may transmit information indicating a preference inquiry to the terminal device 20, receive an answer input by the user to the terminal device 20, and acquire the answer as the preference information in association with the identifier of the answered user. The identifier of the user may be an identifier of the terminal device 20.

The present disclosure is not limited to this, and the control unit 11 may acquire the preference information by generating the preference information based on the purchase history of the product or service of the user. The control unit 11 may acquire the information indicating the purchase history by receiving the information from the terminal device 20. The control unit 11 may acquire the information indicating the purchase history by receiving the information from the terminal device of each store in which the sales history is accumulated in association with the identifier of the user. The control unit 11 may determine a category to which the commodity or the service indicated by the purchase history belongs, and generate preference information according to the category. For example, the control unit 11 determines categories to which the sporting goods, the cooking utensils, and the cosmetics indicated by the purchase history belong as “sports,” “cooking,” and “beauty,” respectively. Any language analysis technique may be employed to determine the category of goods or services. For example, the control unit 11 may generate preference information that sets the preference of the user as “sport” when the number of times of purchase of a product or a service whose category belongs to “sport” is equal to or more than a predetermined number of times or equal to or more than a predetermined amount of money in the purchase history of the user.

In S3, the control unit 11 selects a facility according to the preference information.

The control unit 11 first identifies, as a candidate facility, a facility that is within a predetermined distance from the position of the vehicle V based on the vehicle position information indicating the current position of the vehicle V. Facilities include stores, museums, concert halls, theaters, movie theaters, zoos, aquariums, amusement parks, libraries, and the like. The control unit 11 may specify a plurality of candidate facilities. The vehicle position information may be included in the usage date and time information. The control unit 11 may acquire the vehicle position information by directly receiving the vehicle position information from the vehicle V. The predetermined distance may be freely set in advance. The control unit 11 determines the category of the identified candidate facility, and selects a facility that belongs to the category corresponding to the preference of the user, which is stored in the storage unit 12 in advance, that is, a facility corresponding to the preference information. Any language analysis technique may be employed to determine the category of the facility. The category of the facility may be the same as the preference of the user indicated by the preference information.

For example, the control unit 11 may determine a category to which a facility such as a sporting goods store, a gym, or a sports bar belongs as a category of “sports”. The facility may belong to multiple categories, for example, the sports bar may belong to both “sports” and “eating walk”.

For example, it is assumed that the candidate facilities are the gym A, the beauty salon B, and the clothing shop C, and the control unit 11 determines that the respective categories are “sport”, “beauty”, and “shopping”. It is assumed that the user's preference information indicates “sport” as the user's preference. In this case, the control unit 11 selects the gym A from among the candidate facilities as a facility corresponding to the preference information. The present disclosure is not limited thereto, and the control unit 11 may select a plurality of facilities.

In S4, the control unit 11 acquires, as the parking lot information, information indicating a parking lot attached to the selected facility.

An arbitrary method may be employed for acquiring the parking lot information. For example, the control unit 11 may acquire the parking lot information by referring to a database indicating the parking lot of the facility stored in the storage unit 12 in advance. For example, the control unit 11 may communicate with a terminal device used by an employee of a facility, and acquire parking lot information by receiving parking lot information input to the terminal device by the employee.

The parking lot information may include information indicating coordinates on a map indicating a position of the parking lot, a number indicating a parking lot, a mark of an entrance of the parking lot, and the like. The parking lot information is information indicating a parking space in which two vehicles, namely, the vehicle V and the power supply vehicle CV, can be parked. The parking compartment may be a continuous two-piece compartment. The parking section may be a section separated by a length of a cable included in the power supply vehicle CV. The control unit 11 may communicate with, for example, an external server that manages a parking lot of a facility, receive information indicating a number of an empty parking lot, and acquire parking lot information. When a plurality of facilities are selected in S3, the control unit 11 may acquire parking lot information for each of the plurality of facilities.

In S5, the control unit 11 acquires congestion information indicating the degree of congestion in the selected facility for each predetermined time period.

Any method may be employed for acquiring congestion information. For example, the control unit 11 may acquire the congestion information by receiving the congestion information from an external server that provides the congestion status of an arbitrary facility on the map. For example, the control unit 11 may acquire congestion information by communicating with a terminal device used by an employee of a facility and receiving the congestion information input to the terminal device by the employee.

The congestion information indicates the degree of congestion for each predetermined time period. The predetermined time periods may be set as desired. For example, the predetermined time periods may be time periods of every few hours from the opening time to the closing time of the facility. The degree of congestion may be indicated in stages as “high”, “medium”, and “small”. The degree of congestion may be the number of people in the facility, the density, or the like. When a plurality of facilities are selected in S3, the control unit 11 may acquire congestion information for each of the plurality of facilities.

In S6, the control unit 11 determines, based on the usage date and time information and the congestion information, whether the date and time indicated by the usage date and time information is included in a time period in which the degree of congestion is less than a predetermined value.

The predetermined value may be freely set in advance. The predetermined value may be, for example, a predetermined number of persons, a density, or the like. For example, when the degree of congestion is indicated in a stepwise manner, it is assumed that the predetermined value is “medium”. It is assumed that the degree of congestion in the restaurant facility indicated by the congestion information is about “low” in the time period from 9 a.m. to 11 a.m., about “high” in the time period from 11 a.m. to 2 p.m., about “medium” in the time period from 2 p.m. to 6 p.m., about “high” in the time period from 6 p.m. to 9 p.m., and the date and time indicated by the usage date and time information is 10 a.m. In this case, the control unit 11 determines that the date and time indicated by the usage date and time information is included in a time period in which the degree of congestion is less than a predetermined value, and the process of the control unit 11 proceeds to S6. When the congestion information is acquired for each of the plurality of facilities, the control unit 11 may determine whether the date and time indicated by the usage date and time information is included in a time period in which the degree of congestion is less than a predetermined value for each of the plurality of facilities.

When it is determined that the date and time indicated by the usage date and time information is not included in the time period in which the degree of congestion is less than the predetermined value, the process of the control unit 11 may return to S1. The control unit 11 may return to S1 after the control unit 11 determines that the date and time indicated by the usage date and time information is not included in the time period in which the degree of congestion is less than the predetermined value for all of the plurality of facilities for which the congestion information has been acquired in S5.

In S7, the control unit 11 generates privilege information indicating a privilege that can be used in the facilities when the charging service is used in the parking lot.

Any method may be adopted for generating the privilege information. In the present embodiment, the control unit 11 generates privilege information including a privilege that is of higher value as the amount of time required to use an on-demand charging service is shorter. Specifically, the control unit 11 first communicates with the vehicle V and receives the remaining amount information indicating the remaining amount of the storage battery of the vehicle V. The control unit 11 calculates the amount of time required to complete charging based on the remaining capacity information, and acquires the calculated amount of time as the amount of time required to use the on-demand charging service.

The privilege specifically includes a discount coupon or the like of the facility. The control unit 11 may generate the privilege information including a coupon that has a higher discount rate as the amount of time required to use the on-demand charging service is shorter. In S6, when there are a plurality of facilities in which it is determined that the date and time indicated by the usage date and time information is included in a time period in which the degree of congestion is less than the predetermined value, the control unit 11 may generate the privilege information for each of the plurality of facilities. The present disclosure is not limited to this, and the control unit 11 may acquire the benefit information by directly receiving the privilege information from the terminal device used by the employee of the facility.

The present disclosure is not limited to this, and the control unit 11 may determine to increase the discount rate of the coupon as the amount of time required to use the on-demand charging service is longer or shorter according to the type of the facility. The type of the facility includes, for example, a sports game facility such as a retail store, a restaurant, or a batting center, a game center, and an amusement facility such as a karaoke. The type of the facility may be set for each facility in advance and stored in the storage unit 12.

For example, in a case where the type of the facility is a retail store or a restaurant, the control unit 11 may determine to increase the discount rate of the coupon as the amount of time required to use the on-demand charging service is shorter, and may generate the privilege information including the coupon having a high discount rate. In the case where the type of the facility is a sports game facility or an amusement facility, the control unit 11 may determine to increase the discount rate of the coupon as the amount of time required to use the on-demand charging service is longer, and may generate the privilege information including the coupon having a high discount rate.

The information indicating the degree to which the discount rate is increased may be set in advance according to the type of the facility or the category of the facility described above and stored in the storage unit 12. The control unit 11 can read the information from the storage unit 12 and generate the privilege information including a privilege that is of higher value as the amount of time required to use the charging service in the parking lot is shorter or longer.

In S8, the control unit 11 notifies the user of the parking lot information and the privilege information. Thereafter, the operation of the control device 10 ends.

Any method may be employed for notifying the user. In the present embodiment, the control unit 11 notifies the terminal device 20 of the user by transmitting the parking lot information and the privilege information. In the case where the control device 10 includes an output unit, the control unit 11 may display the privilege information and the parking lot information via the output unit to notify the user.

In addition to the privilege information and the parking lot information, the control unit 11 may transmit, to the terminal device 20, an inquiry as to whether or not to confirm the reservation of the use of the charging service at the date and time indicated by the usage date and time information. The control unit 21 of the terminal device 20 notifies the user of the privilege information, the parking lot information, and the inquiry via the input/output unit 24. The user can input an answer to the inquiry via the input/output unit 24 while viewing the parking lot information and the privilege information. At this time, the privilege information and the parking lot information may be simultaneously displayed on the map in the input/output unit 24. When the parking lot information and the privilege information for the plurality of facilities are received, the control unit 21 may simultaneously display the parking lot information and the privilege information for each of the plurality of facilities on the map. This makes it possible for the user to refer to a plurality of parking lots in a list and compare and examine the locations where the charging service is received.

The control unit 11 of the control device 10 that has received the user's answer from the terminal device 20 may transmit information indicating that the user uses the parking lot to use the charging service at the date and time indicated by the usage date and time information to the terminal device used by the employee of the facility. When the terminal device displays the information to the employee, the employee can recognize that the parking lot is to be used. The control unit 11 may also communicate with the power supply vehicle CV and transmit an instruction to move to the position of the parking lot indicated by the parking lot information at the date and time indicated by the usage date and time information. The control unit of the power supply vehicle CV that has received the signal can control each unit of the power supply vehicle CV by the autonomous driving function to move to the position of the parking lot.

As described above, the control device 10 according to the present embodiment is used to provide a charging service in which the power supply vehicle CV used for charging the vehicle V moves to the source of the vehicle V and charges. The control unit 11 of the control device 10 acquires the usage date and time information indicating the date and time when the user wants to use the charging service, acquires the parking lot information indicating the parking lot attached to the facility that can be used for the charging service, acquires the privilege information indicating the privilege that can be used in the facility when the charging service is used in the parking lot, and notifies the user of the parking lot information and the privilege information. According to the present embodiment, a parking lot attached to a facility and a privilege available in the facility are automatically presented to a user. A location for stopping the power supply vehicle CV is easily found, and the convenience of the on-demand charging service is improved for the user, and the facility uses an empty parking lot to increase the number of users of the facility. Therefore, it is possible to improve a technique for providing a charging service.

As described above, the control unit 11 acquires the preference information indicating the preference of the user, selects the facility according to the preference information, and acquires the information indicating the parking lot attached to the selected facility as the parking lot information. According to the present embodiment, the parking lot of the facility corresponding to the preference of the user is easily presented to the user, and the possibility that the user visits the facility during charging of the vehicle V is increased. Therefore, it is possible to improve a technique for providing a charging service.

As described above, the control unit 11 acquires congestion information indicating the degree of congestion of the facility for each predetermined time period. The control unit 11 determines, based on the usage date and time information and the congestion information, whether the date and time is included in a time period in which the degree of congestion is less than a predetermined value, and when the date and time is included in the time period, notifies the user of the parking lot information and the privilege information. According to the present embodiment, when the facility is congested and it is difficult to provide a parking lot, it is possible to restrict the use for the charging service and to provide a flexible parking lot. Therefore, it is possible to improve a technique for providing a charging service.

As described above, the control unit 11 generates the privilege information including a privilege that is of higher value as the amount of time required to use the charging service in the parking lot is shorter or longer. According to the present embodiment, it is possible to encourage the user to use the facility while reducing or increasing the amount of time during which the parking lot is used for the charging service. Therefore, it is possible to improve a technique for providing a charging service.

Although the present disclosure has been described above based on the drawings and the embodiment, it should be noted that those skilled in the art may make various modifications and alterations thereto based on the present disclosure. It should be noted, therefore, that these modifications and alterations are within the scope of the present disclosure. For example, the functions included in the configurations, steps, etc. can be rearranged so as not to be logically inconsistent, and a plurality of configurations, steps, etc. can be combined into one or divided.

For example, in the above-described embodiment, the configuration and operation of the control device 10 may be distributed among a plurality of computers capable of communicating with each other. Further, for example, an embodiment in which some or all of the components of the control device 10 are provided in the vehicle V is also possible. For example, the navigation device mounted on the vehicle V may include some or all of the components of the control device 10.

### Modified Examples

Next, a modification of the embodiment of the present disclosure will be described. The configuration of the system 1 according to the present modification example and the configuration of each device are the same as those of the above-described embodiment, and thus description thereof will be omitted.

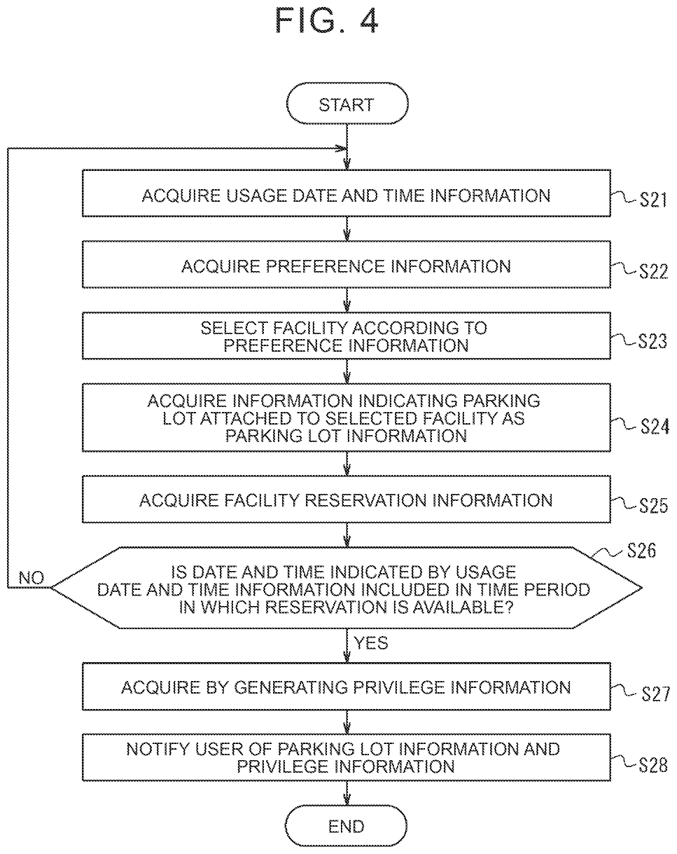

Hereinafter, a difference between the operation of the control device 10 according to the above-described embodiment and the operation of the control device 10 according to the present modification will be described with reference to FIG. 4.

S24 from S21 of FIG. 4 is the same as S4 from S1 of FIG. 3 according to the above-described embodiment, and therefore will not be described.

In S25 of FIG. 4, the control unit 11 acquires facility reservation information indicating whether the selected facility is available to reserve for each time period.

Any method may be adopted for acquiring the facility reservation information. For example, the control unit 11 may communicate with a terminal device used by an employee of the facility and acquire the facility reservation information input to the terminal device by the employee. For example, the control unit 11 may acquire the facility reservation information by receiving the facility reservation information from the management server that manages the reservation of the facility.

The facility reservation information indicates whether the facility is available to reserve for each predetermined time period. The predetermined time periods may be set as desired, and may be, for example, time periods of few hours from the opening time to the closing time of the facility. The facility reservation information may include contents of the reservation. The contents of the reservation include, for example, a reservation of a seat, a reservation of a course, and the like when the facility is a restaurant. The contents of the reservation include, for example, a hair cut reservation, a hair wash reservation, and the like when the facility is a beauty salon. The contents of the reservation include, for example, a reservation of a tour when the facility is an exhibition facility such as an art museum or a museum. When a plurality of facilities are selected in S23, the control unit 11 may acquire the facility reservation information for each of the plurality of facilities.

In S26, the control unit 11 determines, based on the usage date and time information and the facility reservation information, whether the date and time indicated by the usage date and time information is included in the time period in which the facility is available to reserve.

For example, it is assumed that the time periods in which a restaurant has seats available to reserve as indicated by the facility reservation information are the time period from 9 a.m. to 11 a.m. and the time period from 2 p.m. to 6 p.m., and the date and time indicated by the usage date and time information is 3 μm. In this case, the control unit 11 determines that the date and time indicated by the usage date and time information is included in a time period in which the facility is available to reserve, and the process of the control unit 11 proceeds to S27.

When it is determined that the date and time indicated by the usage date and time information is not included in the time period in which the facility is available to reserve, the process of the control unit 11 may return to S1. After the control unit 11 determines, for all of the plurality of facilities for which the facility reservation information has been acquired in S25, that the date and time indicated by the usage date and time information is not included in the time period in which the facility is available to reserve, the process of the control unit 11 may return to S21.

S28 from S27 of FIG. 4 is the same as S8 from S7 of FIG. 3 according to the above-described embodiment, and therefore will not be described.

As described above, in the control device 10 according to the present modification, the control unit 11 acquires the facility reservation information indicating whether the facility is available to reserve for each predetermined time period, determines based on the usage date and time information and the facility reservation information whether the date and time is included in the time period in which the facility is available to reserve, and when the date and time is included in the time period, notifies the user of the parking lot information and the privilege information. According to this modification, it is possible to avoid a situation in which the user cannot use the facility because the facility is fully booked. For the facility side, it is possible to expect an effect of increasing the possibility that the facility is used by the user when the facility is available to reserve. Therefore, it is possible to improve a technique for providing a charging service.

What is claimed is:

1. A method that is performed by a control device that is used to provide a charging service in which a power supply vehicle used to charge a vehicle moves to the vehicle and charges the vehicle, the method comprising:
acquiring usage date and time information indicating a date and time a user wants to use the charging service;
acquiring parking lot information indicating a parking lot attached to a facility and available for the charging service;
acquiring privilege information indicating a privilege available for use at the facility when the charging service is used in the parking lot; and
notifying the user of the parking lot information and the privilege information.

2. The method according to claim 1, further comprising:
acquiring preference information indicating a preference of the user; and
selecting a facility according to the preference information, and acquiring information indicating a parking lot attached to the selected facility as the parking lot information.

3. The method according to claim 1, further comprising:
acquiring congestion information indicating a degree of congestion of the facility for each predetermined time period; and
determining, based on the usage date and time information and the congestion information, whether the date and time is included in the time period in which the degree of congestion is less than a predetermined value, and when the date and time is included in the time period, notifying the user of the parking lot information and the privilege information.

4. The method according to claim 1, further comprising:
acquiring facility reservation information indicating whether the facility is available to reserve for each predetermined time period; and
determining, based on the usage date and time information and the facility reservation information, whether the date and time is included in the time period in which the facility is available to reserve, and when the date and time is included in the time period, notifying the user of the parking lot information and the privilege information.

5. The method according to claim 1, further comprising generating the privilege information including the privilege that is of higher value as an amount of time required to use the charging service in the parking lot is shorter or longer.
